(19) United States
(12) Patent Application Publication
(10) Pub. No.: US 2025/0026475 A1
(43) Pub. Date: Jan. 23, 2025

(54) AN EXTERNAL CARGO ADAPTER FOR USE WITH A ROTORCRAFT

(71) Applicant: AIRBUS HELICOPTERS DEUTSCHLAND GMBH, Donauwörth (DE)

(72) Inventors: Dominik VOGEL, Langweid (DE); Stephan HOLZE, Friedrichsdorf (DE); Alexandru DINCA, Donauwörth (DE); Stefan SALZBURGER, Augsburg (DE); Christoph HEIDER, Rain Am Lech (DE); Lukas BSCHORR, Amerdingen (DE); Alfonso D'AVINO, Augsburg (DE); Juergen LOI, Rain (DE)

(73) Assignee: AIRBUS HELICOPTERS DEUTSCHLAND GMBH, Donauwörth (DE)

(21) Appl. No.: 18/632,974

(22) Filed: Apr. 11, 2024

(30) Foreign Application Priority Data
Jul. 20, 2023 (EP) 23186704.5

(51) Int. Cl. B64D 1/08; B64C 27/26; B64D 1/22

(52) U.S. Cl. CPC B64D 1/08; B64D 1/22; B64C 27/26

(57) ABSTRACT

An external cargo adapter for use with a rotorcraft that comprises at least one carrier station, in particular at least one weapon station, comprising: at least one mounting lug for attachment to the at least one carrier station; at least one cargo carrying ring for connection to a connecting rope adapted for transport of an external cargo; and a connecting member that connects the at least one mounting lug with the at least one cargo carrying ring.

### CROSS-REFERENCE TO RELATED APPLICATION

This application claims priority to European patent application No. EP 23186704.5 filed on Jul. 20, 2023, the disclosure of which is incorporated in its entirety by reference herein.

### TECHNICAL FIELD

The present disclosure is related to an external cargo adapter for use with a rotorcraft that comprises at least one carrier station, in particular at least one weapon station. The present disclosure is further related to a human external cargo transportation arrangement for use with such a rotorcraft, as well as to a human external cargo transportation system.

### BACKGROUND

Rotorcrafts which comprise at least one carrier station, in particular at least one weapon station for carrying weapons externally, are well-known. For instance, the documents US 2020/0298974 A1, US 2004/0216596 A1, and EP 3 909 580 A1 illustrate and/or describe such rotorcrafts, which may also be referred to as “attack helicopters”.

However, such attack helicopters are usually not equipped for transporting on their outside human and/or non-human external cargo in general. Therefore, for instance human external cargo that should be transported with a given attack helicopter is usually e. g. transported on a landing gear and/or one or more stub wings of the given attack helicopter.

Nevertheless, the document US 2022/0169389 A1 describes an attack helicopter that may be adapted for human external cargo transportation. This attack helicopter comprises a modular deployable external passenger system (MDEPS) that mounts to the bomb release unit (BRU) and air launched effect (ALE) launcher rack of the attack helicopter. More specifically, the MDEPS includes a fully internally stowable external passenger seating unit with a plurality of seats, which is affixed to articulating mounts. The external passenger seating unit may be translated between a first position in which the external passenger seating unit is stowed in a payload bay of the attack helicopter and a second position in which the external passenger seating unit is deployed external to the attack helicopter for accommodating at least one passenger.

The document WO 2005/039972 A2, in turn, describes a rotorcraft with a fuselage and pivotable lateral payload bays mounted thereto. The pivotable lateral payload bays may be used for mounting or transporting guns or ammunition, personnel or troops, or cargo in general. They may also be used for evacuating wounded persons, and so on.

Furthermore, human and/or non-human cargo attachment devices for use with suitably equipped rotorcrafts, which are embodied to permit transport of human and/or non-human external cargo outside of the rotorcraft, are available in a wide range of variations and usually attachable to ropes or cables which may be connected to the rotorcrafts. In general, three different types of human and/or non-human cargo attachment devices are currently available: rigging plates or loops of so-called SPIE (Special Patrol Insertion/Extraction) rigs, personal transport nets, and personal transport platforms, all of which are attachable to associated attachment interfaces such as safety hooks or snap hooks provided at associated ropes or cables of rotorcrafts.

However, none of the above-described human and/or non-human cargo attachment devices is suitable for use with any one of the above-described attack helicopters.

It is, therefore, an object of the present disclosure to enable use of an attack helicopter for human and/or non-human external cargo transportation and, more generally, of a rotorcraft which comprises at least one carrier station, in particular at least one weapon station for carrying weapons externally.

### SUMMARY

This object is solved by an external cargo adapter for use with a rotorcraft that comprises at least one carrier station, in particular at least one weapon station, the external cargo adapter. More specifically, according to the present disclosure the external cargo adapter comprises at least one mounting lug for attachment to the at least one carrier station, at least one cargo carrying ring for connection to a connecting rope adapted for transport of an external cargo, and a connecting member that connects the at least one mounting lug with the at least one cargo carrying ring.

Advantageously, the external cargo adapter enables use of the at least one carrier station of the rotorcraft, in particular the at least one weapon station that is conventionally used for carrying weapons, for transport of human and/or non-human external cargo. The external cargo adapter is lightweight and can be carried in the rotorcraft. It may be used without provision of any additional external mechanics on the rotorcraft, such as an additional cargo hook or winch.

In particular, the inventive external cargo adapter is suitable for attachment of comparatively simple and easy to use human external cargo transportation devices and, thus, enables e. g. evacuation of persons out of dangerous areas. Accordingly, a reliable way of evacuating persons from dangerous areas using already existing rotorcraft interfaces may be provided. Thereby, the persons may be picked up with the rotorcraft without a need for landing, which is important for forest areas, unprepared terrain or water.

Preferably, the inventive external cargo adapter is a removable component which is removably attachable to the at least one carrier station via two connector rings. These two rings implement an opening mechanism. The removable component further comprises an attachment for human external cargo. If required, a swivel may also be installed on the removable component. The swivel may e. g. be used for attachment of suitable transporting ropes.

Advantageously, use of the inventive external cargo adapter does not require any fuselage modification and/or modifications to the at least one carrier station, i. e. the at least one weapon station, of the rotorcraft. Accordingly, there is no need for a design change to the rotorcraft. In fact, the external cargo adapter may be attached easily and quickly to the at least one carrier station, i. e. the at least one weapon station, and it may likewise be released easily and quickly, if required.

According to some aspects, the at least one mounting lug comprises an associated lug opening configured for receiving a blocking hook or bar of the at least one carrier station.

According to some aspects, the at least one cargo carrying ring is mounted to the connecting member via a swivel.

According to some aspects, the connecting member is a connecting rail.

The external cargo adapter may further comprise a first mounting lug and a second mounting lug which are spaced apart from each other on the connecting rail.

The first and second mounting lugs and the at least one cargo carrying ring may be mounted to opposite sides of the connecting rail.

Furthermore, a human external cargo transportation arrangement for use with a rotorcraft that comprises at least a first carrier station and a second carrier station, in particular at least a first weapon station and a second weapon station, is provided. The human external cargo transportation arrangement comprises a first external cargo adapter as described hereinabove for attachment to the first carrier station, a second external cargo adapter as described hereinabove for attachment to the second carrier station, a first connecting rope for connection to the first external cargo adapter, and a second connecting rope for connection to the second external cargo adapter. Each one of the first and second connecting ropes is connected to a swivel for connection to at least one first human external cargo attachment rope and one second human external cargo attachment rope.

Advantageously, persons which should be transported as human external cargo with the rotorcraft using the human external cargo transportation arrangement may attach themselves to the rotorcraft over a harness with a swivel in order to allow rotation during flight in order to prevent twisting of the first and second human external cargo attachment ropes and, thus, of the first and second connecting ropes. The swivel may e. g. be positioned on a top end or a bottom end of the first and second connecting ropes. Preferably, more than one swivel is used in the human external cargo transportation arrangement to allow rotation of the human external cargo before and after releasing of one attachment path.

In case of no usage of the human external cargo transportation arrangement, it may be stored inside of the rotorcraft or on one carrier station, i. e. weapon station, in a suitable box that is attachable thereto e. g. using the external cargo adapter described above. In the latter case, all remaining carrier stations, i. e. weapon stations, may be used for transportation of weapons or other stores before a human external cargo operation, which may require two or more external cargo adapters described hereinabove.

Advantageously, the human external cargo transportation arrangement is adapted for creating a redundant connection between the first carrier station and the second carrier station of a rotorcraft. In this redundant connection, if e. g. attachment to the first carrier station fails accidentally or intentionally, for instance due to a defective cargo hook, attachment to the second carrier station still guarantees safety of a respectively transported person. Thus, the applicable FAR regulations for transportation of human external cargo are largely met and the safety of transported persons is increased compared to a transportation on the landing gear or stub wings as described above. With respect to conventional human cargo attachment devices, such as SPIE rigs, the human external cargo transportation arrangement provides for the same level of safety.

In a first illustrative application scenario, two similar loaded ropes implementing the first and second connecting ropes may be attached via the first and second external cargo adapters to the first and second carrier stations, respectively. For instance, the first and second carrier stations are each provided on an associated stub wing of the rotorcraft. Preferably, the first and second connecting ropes are interconnected by means of a swivel. Persons which are to be transported may, thus, attach themselves to the swivel using e. g. a suitable personnel-carrying device system (PCDS) that may also be referred to as “securing harness”. Accordingly, two securing harnesses would be used, which implement or comprise the first and second human external cargo attachment ropes that may have different lengths. The swivel enables rotation of the persons which are to be transported during normal operation.

In case of release of one of the first and second external cargo adapters from the first and second carrier stations, the persons which are to be transported switch from two connection points to only one connection point. However, in any case transportation is still possible and rotating movements are still allowed by the swivel. Furthermore, the released one of the first and second external cargo adapters is not lost and still attached via the respective one of the first and second connecting ropes to the swivel.

In a second illustrative application scenario, an improved visibility during flight of the rotorcraft is enabled. More specifically, the first and second connecting ropes may again be attached via the first and second external cargo adapters to the first and second carrier stations, respectively. For instance, the first and second carrier stations are each again provided on an associated stub wing of the rotorcraft. However, in contrast to the first illustrative application scenario, the first and second connecting ropes may now be connected to first and second swivels, respectively. Moreover, first and second redundant ropes may now be attached to the first and second swivels, respectively, and to the first and second external cargo adapters, respectively. In addition, the first and second external cargo adapters may now be interconnected via a safety rope.

Persons which are to be transported may, thus, attach themselves to the first swivel or the second swivel using e. g. a suitable securing harness. The first and second swivels enable rotation of the persons which are to be transported during normal operation.

In case of release of one of the first and second external cargo adapters from the first and second carrier stations, the persons which are to be transported switch again from two connection points to only one connection point. Advantageously, the safety rope ensures after the release a small falling height of the released one of the first and second external cargo adapters in order not to injure the other person upon release.

However, in any case transportation is still possible and rotating movements are still allowed by the first or second swivel. Furthermore, the released one of the first and second external cargo adapters is not lost and still at least attached to the safety rope.

In a third illustrative application scenario, an improved visibility during flight of the rotorcraft is again enabled. More specifically, two so-called Y-ropes implementing the first and second connecting ropes may be attached via a total of four external cargo adapters to four carrier stations, respectively. For instance, first and second carrier stations are provided on an associated stub wing of the rotorcraft, and second and third carrier stations are provided on another stub wing of the rotorcraft. Preferably, the first and second connecting ropes are connected to first and second swivels, respectively. Persons which are to be transported may, thus, attach themselves to the first swivel or the second swivel using e. g. a suitable securing harness. The first and second swivels enable rotation of the persons which are to be transported during normal operation.

In case of release of one of a first and second or third and fourth external cargo adapters from the first and second or third and fourth carrier stations, the persons which are to be transported switch from two connection points to only one connection point. However, in any case transportation is still possible and rotating movements are still allowed by the first and second swivel. Furthermore, the released one of the external cargo adapters is not lost and still attached to an associated one of the two Y-ropes.

Advantageously, after release of one of a first and second or third and fourth external cargo adapters from the first and second or third and fourth carrier stations, the rotorcraft is still symmetrically loaded. Nevertheless, only a single person may be transported on each one of the stub wings and is attached to only one of the stub wings.

According to some aspects, the first and second connecting ropes are connected to a single swivel that attaches the first connecting rope to the second connecting rope.

According to some aspects, the first connecting rope is connected to a first swivel for connection to the second human external cargo attachment rope, and the second connecting rope is connected to a second swivel for connection to the first human external cargo attachment rope. The first swivel is further connected to a first redundant rope provided for connection to the second external cargo adapter, and the second swivel is further connected to a second redundant rope provided for connection to the first external cargo adapter.

The human external cargo transportation arrangement may further comprise a safety rope for connection of the first external cargo adapter with the second external cargo adapter.

According to some aspects, the human external cargo transportation arrangement may comprise a third external cargo adapter as described hereinabove for attachment to a third carrier station of the rotorcraft, and a fourth external cargo adapter as described hereinabove for attachment to a fourth carrier station of the rotorcraft. The first connecting rope is a first Y-rope for connection to the first external cargo adapter and the third external cargo adapter, and the second connecting rope is a second Y-rope for connection to the second external cargo adapter and the fourth external cargo adapter.

Moreover, a human external cargo transportation system is provided. The human external cargo transportation system comprises a rotorcraft with at least one carrier station, in particular at least one weapon station, and a human external cargo transportation arrangement as described hereinabove.

According to some aspects, the rotorcraft comprises a wing arrangement with at least one left-hand side wing and one right-hand side wing. The left-hand side wing comprises at least the first carrier station, and the right-hand side wing comprises at least the second carrier station.

The wing arrangement may be a stub wing arrangement, wherein the left-hand side wing and the right-hand side wing are stub wings.

According to some aspects, the rotorcraft is an attack helicopter.

### BRIEF DESCRIPTION OF THE DRAWINGS

Preferred embodiments of the disclosure are outlined by way of example in the following description with reference to the attached drawings. In these attached drawings, identical or identically functioning components and elements are labeled with identical reference numbers and characters and are, consequently, only described once in the following description;

FIG. 1 shows a front view of a rotorcraft with a plurality of carrier stations, in particular a plurality of weapon stations, provided on stub wings of the rotorcraft;

FIG. 2 shows a perspective view of one of the stub wings of FIG. 1 with associated carrier stations;

FIG. 3 shows a perspective view of an external cargo adapter for use with one of the carrier stations of FIG. 2, according to the present disclosure; and

FIG. 4A to FIG. 6C show front views of a human external cargo transportation system according to the present disclosure.

### DETAILED DESCRIPTION

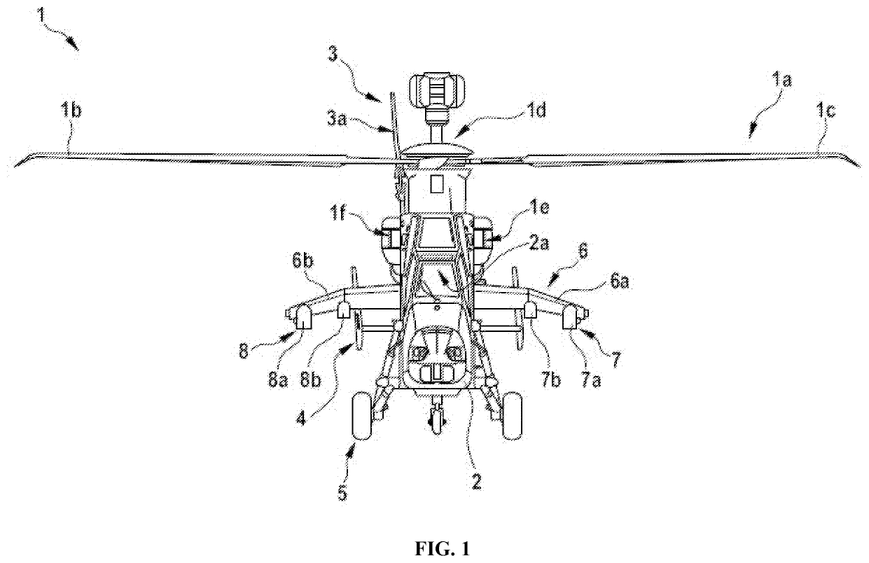

FIG. 1 shows a rotorcraft 1 that is, by way of example, embodied as a helicopter and, more particularly, as a so-called attack helicopter. Thus, for purposes of simplicity and clarity, the rotorcraft 1 is hereinafter referred to as the “attack helicopter 1”. The present disclosure is, however, not limited to attack helicopters and may likewise be applied to any other rotorcraft that is adapted for vertical takeoff and landing.

Illustratively, the attack helicopter 1 comprises at least one rotor 1a that may be powered by two engines 1e, 1f for providing lift and forward or backward thrust during operation. By way of example, the at least one rotor 1a is a multi-blade main rotor that comprises a plurality of rotor blades which are connected at a rotor head 1d to an associated rotor shaft that rotates in operation of the attack helicopter 1 about an associated rotor axis. Two rotor blades of the plurality of rotor blades are illustratively separately labelled with the reference signs 1b, 1c.

Moreover, the attack helicopter 1 preferably comprises a fuselage 2 to which a landing gear 5 of the wheel-type may be attached. Illustratively, the fuselage 2 forms an aircraft interior region that accommodates at least a cockpit 2a.

Furthermore, the attack helicopter 1 preferably comprises at least one counter-torque device 3 configured to provide counter-torque during operation, i. e. to counter the torque created by rotation of the at least one rotor 1a for purposes of balancing the attack helicopter 1 in terms of yaw. The at least one counter-torque device 3 is illustratively provided at an aft section of the attack helicopter 1 and preferably comprises a tail rotor 3a. The aft section of the attack helicopter 1 may further be provided with a horizontal stabilizer 4. By way of example, the attack helicopter 1 may be provided with a tail boom to which the counter-torque device 3 and the horizontal stabilizer 4 are mounted.

Illustratively, the attack helicopter 1 further comprises a wing arrangement 6. More specifically, the wing arrangement 6 comprises two separate wings 6a, 6b. The wing 6a is a left-hand side wing, seen in forward flight direction of the attack helicopter 1, and the wing 6b is a right-hand side wing, seen in forward flight direction of the attack helicopter 1. By way of example, the wing arrangement 6 is a stub wing arrangement, wherein the wing 6a is a left-hand side stub wing and wherein the wing 6b is a right-hand side stub wing.

Preferably, the stub wing arrangement 6 is equipped with associated carrier stations 7, 8. Illustratively, the left-hand side stub wing 6a is equipped with an outboard sub wing carrier station 7a and an inboard sub wing carrier station 7b, and the right-hand side stub wing 6b is equipped with an outboard sub wing carrier station 8a and an inboard sub wing carrier station 8b.

However, it should be noted that the present disclosure is not limited to provision of the carrier stations 7, 8 as sub wing carrier stations on the stub wing arrangement 6. Alternatively, or in addition, the carrier stations 7, 8 or other suitable carrier stations may e. g. be provided on an underside of the fuselage 2, or they may be attached to the landing gear 5, and so on.

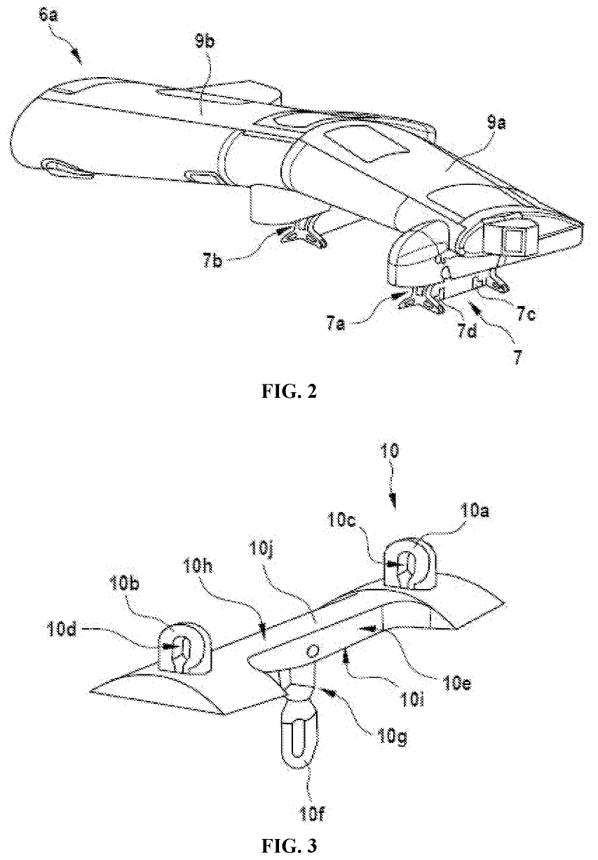

FIG. 2 shows the left-hand stub wing 6a of FIG. 1 with the carrier stations 7 which comprise the outboard sub wing carrier station 7a and the inboard sub wing carrier station 7b of FIG. 1. Illustratively, the outboard sub wing carrier station 7a is mounted to an outboard section 9a of the left-hand stub wing 6a and the inboard sub wing carrier station 7b is mounted to an inboard section 9b of the left-hand stub wing 6a. By way of example, the outboard sub wing carrier station 7a is shown with two blocking hooks or bars 7c, 7d.

At this point, it should be noted that the outboard sub wing carrier station 7a is only shown and explained in more detail representative for all sub wing carrier stations 7a, 7b, 8a, 8b of FIG. 1. In other words, each one of the sub wing carrier stations 7a, 7b, 8a, 8b of FIG. 1 preferably comprises respective blocking hooks or bars.

It should further be noted that the outboard sub wing carrier station 7a, and likewise each other one of the sub wing carrier stations 7b, 8a, 8b of FIG. 1, is preferably embodied as a weapon station which is provided for transportation of weapons or ammunition, but which may e. g. also be used for transportation of additional fuel tanks. Such a weapon station, which may also be referred to as a “bomb rack” or “bomb ejector rack”, is, however, well-known to the person skilled in the art so that a detailed description of the weapon stations 7a, 7b, 8a, 8b may be omitted, for brevity and conciseness.

FIG. 3 shows an external cargo adapter 10 according to the present disclosure. The external cargo adapter 10 is provided for use with a rotorcraft that comprises at least one carrier station, in particular at least one weapon station, such as e. g. the attack helicopter 1 of FIG. 1. More specifically, the external cargo adapter 10 is preferably suitable for transportation of human and/or non-human external cargo.

The external cargo adapter 10 comprises at least one mounting lug for attachment to an associated carrier station, e. g. one of the sub wing carrier stations 7a, 7b, 8a, 8b of FIG. 1. By way of example, two mounting lugs 10a, 10b are provided, which may e. g. be blocked at the carrier station 7a of FIG. 2 via the blocking hooks or bars 7c, 7d. Therefore, each one of the two mounting lugs 10a, 10b preferably comprises an associated lug opening 10c, 10d configured for receiving e. g. one of the blocking hooks or bars 7c, 7d.

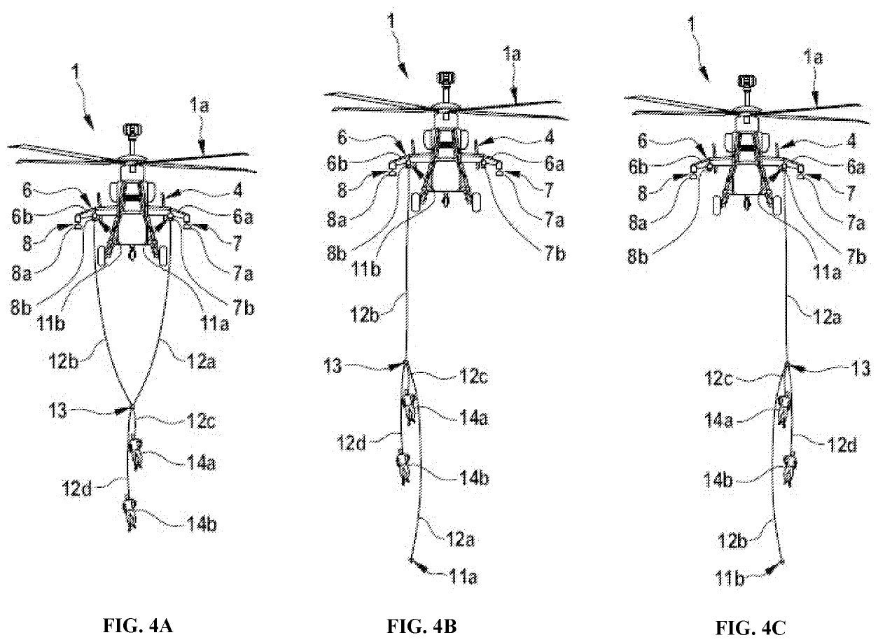

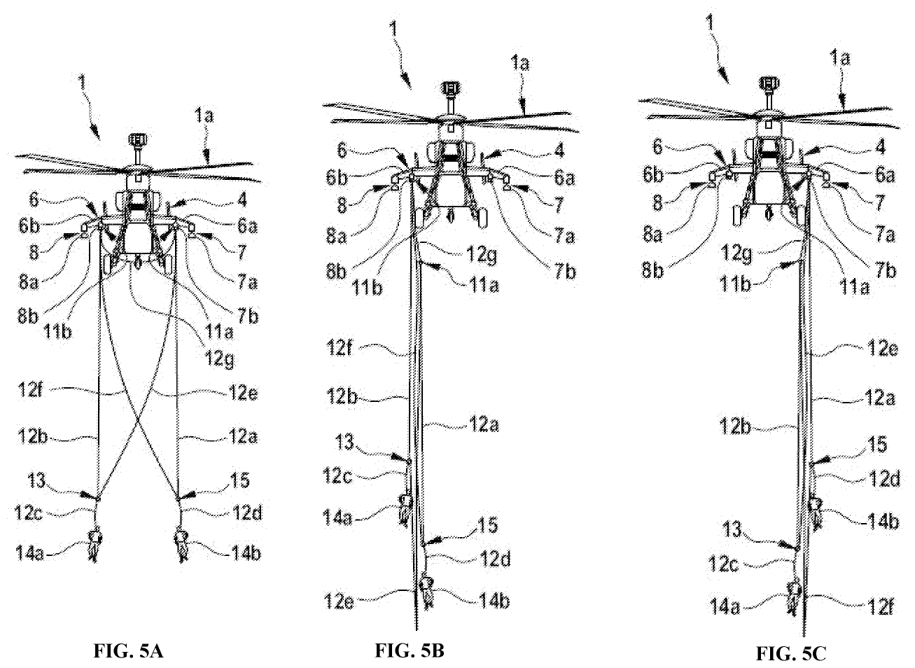

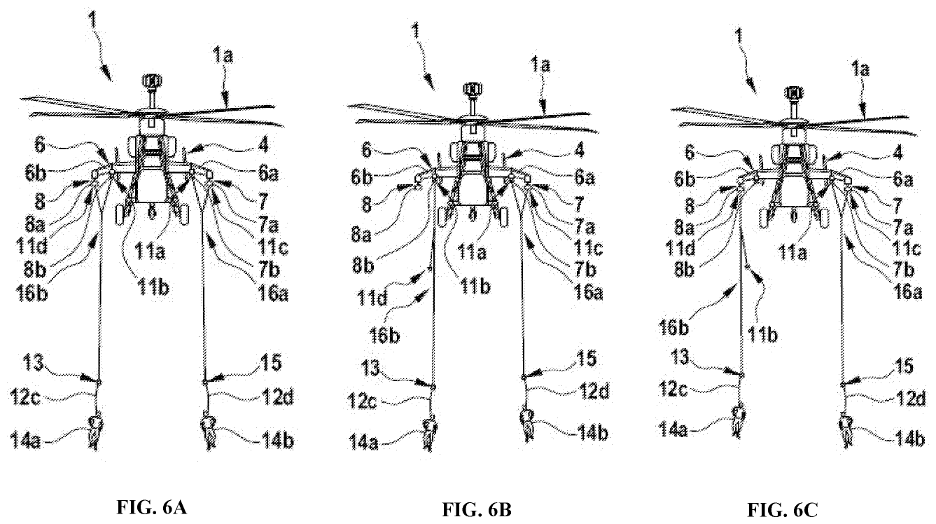

The external cargo adapter 10 further comprises at least one and, illustratively, exactly one cargo carrying ring 10f. The cargo carrying ring 10f is provided for connection to at least one connecting rope (e. g. connecting ropes 12a, 12b in FIG. 4 and FIG. 5, or 16a, 16b in FIG. 6) adapted for transport of an external cargo.

The cargo carrying ring 10f and the two mounting lugs 10a, 10b are connected to each other via a connecting member 10e. Preferably, the cargo carrying ring 10f is mounted to the connecting member 10e via a swivel 10g. By way of example, the connecting member 10e is a connecting rail 10j.

Illustratively, the two mounting lugs 10a, 10b and the cargo carrying ring 10f are mounted to opposite sides 10h, 10i of the connecting rail 10j. Furthermore, the two mounting lugs 10a, 10b are preferably spaced apart from each other on the connecting rail 10j.

FIG. 4 shows in parts (A) to (C) a human external cargo transportation system according to the present disclosure. The human external cargo transportation system comprises a rotorcraft with at least one carrier station, in particular at least one weapon station, and a human external cargo transportation arrangement.

By way of example, the rotorcraft is the attack helicopter 1 of FIG. 1 with the carrier stations 7, 8. As described above, the carrier stations 7, 8 comprise the sub wing carrier stations 7a, 7b, 8a, 8b of FIG. 1 which are embodied as described above at FIG. 2 and arranged on the left-hand side stub wing 6a and the right-hand side stub wing 6b of the stub wing arrangement 6 of the attack helicopter 1, respectively.

According to part (A), the human external cargo transportation arrangement comprises a first external cargo adapter 11a for attachment to a first carrier station, and a second external cargo adapter 11b for attachment to a second carrier station. Each one of the external cargo adapters 11a, 11b is preferably embodied in accordance with the external cargo adapter 10 of FIG. 3.

Illustratively, the external cargo adapter 11a is attached to the sub wing carrier station 7b and the external cargo adapter 11b is attached to the sub wing carrier station 8b. Thus, the sub wing carrier stations 7a, 8a are kept free and may, for instance, still be used for transportation of weapons, ammunition, or additional fuel tanks.

The human external cargo transportation arrangement further comprises a first connecting rope for connection to the external cargo adapter 11a, and a second connecting rope for connection to the external cargo adapter 11b. Illustratively, a first connecting rope 12a is attached to the external cargo adapter 11a, and a second connecting rope 12b is attached to the external cargo adapter 11b.

Furthermore, the connecting ropes 12a, 12b are both connected to a common swivel 13 which, thus, connects the connecting rope 12a with the connecting rope 12b. The common swivel 13 is provided for connection to at least one first human external cargo attachment rope and one second human external cargo attachment rope. By way of example, a first human external cargo attachment rope 12c and a second human external cargo attachment rope 12d are attached to the common swivel 13.

Illustratively, a first person 14a is attached as human external cargo to the human external cargo attachment rope 12c and a second person 14b is attached as human external cargo to the human external cargo attachment rope 12d. The persons 14a, 14b may, for instance, be equipped with individual securing harnesses which are provided with, or attached to, the human external cargo attachment ropes 12c, 12d. However, such securing harnesses are well-known to the person skilled in the art so that a detailed description thereof can be omitted, for brevity and conciseness.

In part (A) of FIG. 4, the human external cargo transportation system is shown in normal operation mode during flight of the attack helicopter 1. Accordingly, both external cargo adapters 11a, 11b are correctly attached to the sub wing carrier stations 7b, 8b.

Part (B) shows a scenario, in which the external cargo adapter 11a is accidentally or intentionally released from the sub wing carrier station 7b. In this scenario, the external cargo adapter 11a falls down by gravity below the two persons 14a, 14b, but is not lost and, instead, still attached to the common swivel 13 via the connecting rope 12a. In particular, both persons 14a, 14b are still attached via the human external cargo attachment ropes 12c, 12d, the common swivel 13, the connecting rope 12b, and the external cargo adapter 11b to the sub wing carrier station 8b so that a further safe transportation is guaranteed.

Part (C), in turn, shows a scenario, in which the external cargo adapter 11b is accidentally or intentionally released from the sub wing carrier station 8b. In this scenario, the external cargo adapter 11b falls down by gravity below the two persons 14a, 14b, but is not lost and, instead, still attached to the common swivel 13 via the connecting rope 12b. In particular, both persons 14a, 14b are still attached via the human external cargo attachment ropes 12c, 12d, the common swivel 13, the connecting rope 12a, and the external cargo adapter 11a to the sub wing carrier station 7b so that a further safe transportation is guaranteed.

FIG. 5 shows in parts (A) to (C) a variant of the human external cargo transportation system of FIG. 4, which comprises the attack helicopter 1 and the human external cargo transportation arrangement of FIG. 4. However, the human external cargo transportation arrangement now comprises in addition to the external cargo adapters 11a, 11b, the connecting ropes 12a, 12b, the swivel 13, and the human external cargo attachment ropes 12c, 12d two redundant ropes and a safety rope. Moreover, two separate swivels are provided instead of the single common swivel 13 of FIG. 4.

More specifically, according to part (A) the connecting rope 12a is now attached to a first swivel 15 and the connecting rope 12b is now attached to a second swivel, e. g. the swivel 13 of FIG. 4. Illustratively, the swivel 15 is further attached to a first redundant rope 12f that is also attached to the external cargo adapter 11b, and the swivel 13 is further attached to a second redundant rope 12e that is also attached to the external cargo adapter 11a. Furthermore, a safety rope 12g is attached to both external cargo adapters 11a, 11b and, thus, connects the external cargo adapter 11a with the external cargo adapter 11b. Moreover, the human external cargo attachment rope 12c is attached to the swivel 13 and the human external cargo attachment rope 12d is attached to the swivel 15. The first person 14a is attached as human external cargo to the human external cargo attachment rope 12c and the second person 14b is attached as human external cargo to the human external cargo attachment rope 12d.

In part (A) of FIG. 5, the human external cargo transportation system is shown in normal operation mode during flight of the attack helicopter 1. Accordingly, both external cargo adapters 11a, 11b are correctly attached to the sub wing carrier stations 7b, 8b, and the sub wing carrier stations 7a, 8a are kept free and may, for instance, still be used for transportation of weapons, ammunition, or additional fuel tanks.

Part (B) shows a scenario, in which the external cargo adapter 11a is accidentally or intentionally released from the sub wing carrier station 7b. In this scenario, the external cargo adapter 11a falls down by gravity as far as the safety rope 12g allows, but is not lost and, instead, still attached to the external cargo adapter 11b via the safety rope 12g. In particular, the first person 14a is still attached via the human external cargo attachment rope 12c, the swivel 13, the connecting rope 12b, and the external cargo adapter 11b to the sub wing carrier station 8b, and the second person 14b is still attached via the human external cargo attachment rope 12d, the swivel 15, the redundant rope 12f, and the external cargo adapter 11b to the sub wing carrier station 8b, so that a further safe transportation of both persons 14a, 14b is guaranteed.

Part (C), in turn, shows a scenario, in which the external cargo adapter 11b is accidentally or intentionally released from the sub wing carrier station 8b. In this scenario, the external cargo adapter 11b falls down by gravity as far as the safety rope 12g allows, but is not lost and, instead, still attached to the external cargo adapter 11a via the safety rope 12g. In particular, the first person 14a is still attached via the human external cargo attachment rope 12c, the swivel 13, the redundant rope 12e, and the external cargo adapter 11a to the sub wing carrier station 7b, and the second person 14b is still attached via the human external cargo attachment rope 12d, the swivel 15, the connecting rope 12a, and the external cargo adapter 11a to the sub wing carrier station 7b, so that a further safe transportation of both persons 14a, 14b is guaranteed.

FIG. 6 shows in parts (A) to (C) another variant of the human external cargo transportation system of FIG. 4, which comprises the attack helicopter 1 with the four sub wing carrier stations 7a, 7b, 8a, 8b of FIG. 4, and the human external cargo transportation arrangement of FIG. 4. However, the human external cargo transportation arrangement now comprises two so-called Y-ropes 16a, 16b instead of the connecting ropes 12a, 12b of FIG. 4 and two separate swivels are provided instead of the single common swivel 13 of FIG. 4. However, such Y-ropes are well-known to the person skilled in the art so that a detailed description thereof can be omitted, for brevity and conciseness. Furthermore, two additional external cargo adapters 11c, 11d are provided. Each one of the two additional external cargo adapters 11c, 11d is preferably embodied in accordance with the external cargo adapter 10 of FIG. 3.

More specifically, according to part (A) the Y-rope 16a is attached to a first swivel, e. g. the swivel 15 of FIG. 5, and the Y-rope 16b is attached to a second swivel, e. g. the swivel 13 of FIG. 4. Illustratively, the two upper branches of the Y-rope 16a, which may have different lengths, are attached via the external cargo adapters 11a, 11c to the sub wing carrier stations 7b, 7a, respectively. Likewise, the two upper branches of the Y-rope 16b, which may also have different lengths, are attached via the external cargo adapters 11b, 11d to the sub wing carrier stations 8b, 8a, respectively.

Furthermore, similar to FIG. 5 the human external cargo attachment rope 12c is attached to the swivel 13 and the human external cargo attachment rope 12d is attached to the swivel 15. The first person 14a is attached as human external cargo to the human external cargo attachment rope 12c and the second person 14b is attached as human external cargo to the human external cargo attachment rope 12d.

In part (A) of FIG. 6, the human external cargo transportation system is shown in normal operation mode during flight of the attack helicopter 1. Accordingly, all four external cargo adapters 11a, 11b, 11c, 11d are correctly attached to the sub wing carrier stations 7b, 8b, 7a, 8a.

Part (B) shows a scenario, in which the external cargo adapter 11d is accidentally or intentionally released from the sub wing carrier station 8a. In this scenario, the external cargo adapter 11d falls down by gravity as far as the respective branch of the Y-rope 16b allows, but is not lost and, instead, still attached to the external cargo adapter 11b via the Y-rope 16b. In particular, the first person 14a is still attached via the human external cargo attachment rope 12c, the swivel 13, the Y-rope 16b, and the external cargo adapter 11b to the sub wing carrier station 8b, so that a further safe transportation of the first person 14a is guaranteed.

Part (C), in turn, shows a scenario, in which the external cargo adapter 11b is accidentally or intentionally released from the sub wing carrier station 8b. In this scenario, the external cargo adapter 11b falls down by gravity as far as the respective branch of the Y-rope 16b allows, but is not lost and, instead, still attached to the external cargo adapter 11d via the Y-rope 16b. In particular, the first person 14a is still attached via the human external cargo attachment rope 12c, the swivel 13, the Y-rope 16b, and the external cargo adapter 11d to the sub wing carrier station 8a, so that a further safe transportation of the first person 14a is guaranteed.

### REFERENCE LIST

1 rotorcraft
1a main rotor
1b, 1c rotor blades
1d rotor head
1e, 1f engines
2 fuselage
2a cockpit
3 counter-torque device
3a tail rotor
4 horizontal stabilizer
5 wheel-type landing gear
6 stub wing arrangement
6a left-hand side stub wing
6b right-hand side stub wing
7, 8 carrier stations
7a, 8a outboard sub wing carrier stations
7b, 8b inboard sub wing carrier stations
7c, 7d carrier station hooks or bars
9a stub wing outboard section
9b stub wing inboard section
10 human and/or non-human external cargo adapter
10a, 10b mounting lugs
10c, 10d mounting lug openings
10e connecting member
10f cargo carrying ring
10g swivel
10h adapter rail upper side
10i adapter rail lower side
10j adapter rail
11a, 11b, 11c, 11d individual adapters
12a, 12b connecting ropes
12c, 12d attachment ropes
12e, 12f redundant ropes
12g safety rope
13, 15 swivels
14a, 14b human external cargo
16a, 16b Y-ropes

What is claimed is:

1. An external cargo adapter for use with a rotorcraft that comprises at least one carrier station, in particular at least one weapon station, comprising:
at least one mounting lug for attachment to the at least one carrier station;
at least one cargo carrying ring for connection to a connecting rope adapted for transport of an external cargo; and
a connecting member that connects the at least one mounting lug with the at least one cargo carrying ring.

2. The external cargo adapter of claim 1, wherein the at least one mounting lug comprises an associated lug opening configured for receiving a blocking hook or bar of the at least one carrier station.

3. The external cargo adapter of claim 1, wherein the at least one cargo carrying ring is mounted to the connecting member via a swivel.

4. The external cargo adapter of claim 1, wherein the connecting member is a connecting rail.

5. The external cargo adapter of claim 4, comprising a first mounting lug and a second mounting lug which are spaced apart from each other on the connecting rail.

6. The external cargo adapter of claim 5, wherein the first and second mounting lugs and the at least one cargo carrying ring are mounted to opposite sides of the connecting rail.

7. A human external cargo transportation arrangement for use with a rotorcraft that comprises at least a first carrier station and a second carrier station, in particular at least a first weapon station and a second weapon station, comprising:
a first external cargo adapter for attachment to the first carrier station;
a second external cargo adapter for attachment to the second carrier station;
the first and second external cargo adapters including the external cargo adapter of claim 1;
a first connecting rope for connection to the first external cargo adapter; and
a second connecting rope for connection to the second external cargo adapter;
wherein each one of the first and second connecting ropes is connected to a swivel for connection to at least one first human external cargo attachment rope and one second human external cargo attachment rope.

8. The human external cargo transportation arrangement of claim 7, wherein the first and second connecting ropes are connected to a single swivel that attaches the first connecting rope to the second connecting rope.

9. The human external cargo transportation arrangement of claim 7, wherein the first connecting rope is connected to a first swivel for connection to the second human external cargo attachment rope; wherein the second connecting rope is connected to a second swivel for connection to the first human external cargo attachment rope; wherein the first swivel is further connected to a first redundant rope provided for connection to the second external cargo adapter; and wherein the second swivel is further connected to a second redundant rope provided for connection to the first external cargo adapter.

10. The human external cargo transportation arrangement of claim 9, further comprising a safety rope for connection of the first external cargo adapter with the second external cargo adapter.

11. The human external cargo transportation arrangement of claim 7, further comprising
a third external cargo adapter for attachment to a third carrier station of the rotorcraft, the third external cargo adapter having
at least one mounting lug for attachment to the third carrier station;
at least one cargo carrying ring for connection to a connecting rope adapted for transport of an external cargo; and
a connecting member that connects the at least one mounting lug with the at least one cargo carrying ring; and
a fourth external cargo adapter for attachment to a fourth carrier station of the rotorcraft, the fourth external cargo adapter having
at least one mounting lug for attachment to the fourth carrier station;
at least one cargo carrying ring for connection to a connecting rope adapted for transport of an external cargo; and
a connecting member that connects the at least one mounting lug with the at least one cargo carrying ring;
wherein the first connecting rope is a first Y-rope for connection to the first external cargo adapter and the third external cargo adapter; and wherein the second connecting rope is a second Y-rope for connection to the second external cargo adapter and the fourth external cargo adapter.

12. A human external cargo transportation system, comprising:
a rotorcraft with at least one carrier station, in particular at least one weapon station; and
a human external cargo transportation arrangement according to claim 7.

13. The human external cargo transportation system of claim 12, wherein the rotorcraft comprises a wing arrangement with at least one left-hand side wing and one right-hand side wing; wherein the left-hand side wing comprises at least the first carrier station; and wherein the right-hand side wing comprises at least the second carrier station.

14. The human external cargo transportation system of claim 13, wherein the wing arrangement is a stub wing arrangement, and wherein the left-hand side wing and the right-hand side wing are stub wings.

15. The human external cargo transportation system of claim 12, wherein the rotorcraft is an attack helicopter.
